(19) United States
(12) Patent Application Publication
(10) Pub. No.: US 2005/0253776 A1
(43) Pub. Date: Nov. 17, 2005

(54) System and method for projecting images in an electronic device

(75) Inventors: Sangrok Lee, Durham, NC (US); Kristina Johnson, Durham, NC (US)

Correspondence Address: FLESHNER & KIM, LLP, P.O. BOX 221200, CHANTILLY, VA, 20153, US

(73) Assignee: Duke University

(21) Appl. No.: 10/842,519

(22) Filed: May 11, 2004

(51) Int. Cl. G09G 5/00

(52) U.S. Cl. 345/1.3

(57) ABSTRACT

A portable computer includes an adjuster for varying the throw distance of a projected image. The computer include a housing, a screen connected to the housing, and an image projector coupled to the housing in alignment with the screen. The screen has at least one size dimension that is different from a corresponding size dimension of the housing. In order to achieve the reduced size dimension, the screen may be foldable into a predetermined number of sections. The adjuster varies throw distance by moving the screen relative to the projector. The movement may be manually or automatically initiated and the screen may be adapted to be stored within the device housing when not in use.

### BACKGROUND OF THE INVENTION

1. Field of the Invention

This invention generally relates to displaying images, and more particularly to a system and method for projecting images in portable computers or other electronic devices.

2. Description of the Related Art

Laptop, notebook, and other computing devices have proven to be desirable tools in business and personal information management. They are not without drawbacks, however. One significant drawback relates to size. While efforts are continuously being made towards miniaturization, one hardware feature that has consistently frustrated this goal is the display. This is especially true of computing devices which use direct-view displays.

FIG. 1 shows a conventional notebook computer that includes a direct-view display 1. This display is pivotally mounted to a main housing 2, which includes a CPU motherboard and a number of peripheral devices such as a keyboard, touch pad, and input/output ports, and one or more disk drives. In a notebook of this type, the TFT LCD display window (typically 14.4 inches in size) predominantly determines the area (or so-called footprint) of the computer. As a general rule, the area of the computer>the area of the display window (or image size). This limitation deters miniaturization efforts and complicates the ability to display large-size images in portable devices that are compact in size.

Portable computers which use other types of display systems have the same drawback. For example, FIG. 2 shows a notebook computer that includes a projection display system pivotally connected to a main housing 3. In this system, an LCD projector 4 is located behind a keyboard 5 and casts an image onto a screen 6 secured to an adjacent side of the computer housing. U.S. Pat. No. 5,510,806 discloses a computer of this type which has proven to be disadvantageous for at least the following reasons.

First, the size of the screen limits miniaturization; put differently, the screen and the main computer housing are required to be the same size. The computer therefore can only be made as small as the size of the screen.

Second, images are projected onto the screen at an improper throw distance. With a wide-angle projection lens, whose maximum throw distance ratio is about 1, the width of the display image is the throw distance (typically the distance between the projection lens and the center of the screen). The maximum image size is about 5 to 6 inches wide assuming a diagonal screen size is about 14 inches. Thus, the maximum image size that can be generated with this structure is smaller than the actual screen size.

More specifically, in FIG. 2-type computers the projector is mounted too closely to the screen. As a result, the projected image is smaller than the screen which is not optimal. This effect is more clearly evident from FIG. 3, which shows that projected image 8 is substantially smaller than the dimensions of screen 6 by an mount “a” in the vertical direction and “b” in the horizontal direction. Portable computers such as shown in FIGS. 2 and 3 therefore do not fully utilize the benefits of their projection systems.

In view of the foregoing considerations, it is clear that there is a need for an improved system and method for projecting images in portable computers or other electronic devices.

### SUMMARY OF THE INVENTION

An object of the present invention is to provide an improved system and method for projecting images in portable computing or other electronic devices.

Another object of the present invention is to provide a projection system of the aforementioned type which does not limit the size of the electronic device, thereby promoting miniaturization.

Another object of the present invention is to provide a projection system of the aforementioned type which allows a throw distance of images projected on a screen of the electronic device to be adjusted according to user preferences or to one or more predetermined settings.

These and other objects and advantages of the present invention are achieved by providing an electronic device which according to one embodiment includes a housing, a screen connected to the housing, and an image projector coupled to the housing in alignment with the screen, wherein the screen has at least one size dimension that is substantially smaller than a corresponding size dimension of the housing. In order to achieve the reduced size dimension, the screen may be foldable into a predetermined number of sections, e.g., 2 or more. The sections are preferably of equal size but not necessarily so and may be made from a variety of materials. Preferably, the screen is made from a light-weight material so as not to appreciably increase the carrying weight of the device.

In accordance with another embodiment, the present invention provides an electronic device which includes a housing, a screen connected to the housing, an image projector coupled to the housing in alignment with the screen, and an adjuster which varies a throw distance of an image cast from the projector onto the screen. The adjuster varies the throw distance by increasing or decreasing the space separating the screen and projector. This may be accomplished by mounting the screen on one or more extension members which, for example, may be telescopic in nature or may include one or more rails designed to slide through a respective number of slots in the housing. While these telescopic and rail-based arrangements are advantageous, other adjusting arrangements may alternatively be used.

To achieve optimal viewing, the adjuster may vary the throw distance so that the projected image has a dimension substantially equal to a corresponding dimension of the screen. Preferably, the throw distance is adjusted so that both dimensions (width and height) of the image and screen are equal. Optionally but desirably, one or more guides or guide members may be included to regulate the adjuster to predetermined settings corresponding to desired throw distances.

The adjuster may be automatically or manually controlled to perform the desired adjustments.

Automatic control may be achieved through small servo motors included in the device housing. A separate switch or dial disposed on or otherwise coupled to the device may control extension and retraction of the screen relative to the projector, and the guides may be inscribed or otherwise associated with the control switch or dial. Alternatively, the distance between the projector and screen may be varied by control software, which, for example, causes one or more soft-switch icons or control windows to be displayed for manipulation by a user. In this case, the guides may be programmed into the control software for regulating the distance between the projector and screen to predetermined settings.

Manual control of the adjuster may be accomplished as a result of a user pulling or pushing the screen along the extension rails. If the adjuster includes one or more rails which slide through slots in the housing, the guides may be formed as notches in the rail which corresponding to predetermined throw distances. If the guides are formed as telescoping rails, the length of each telescoping portion may corresponding to a predetermined throw-distance setting. Other manual arrangements are also possible.

In accordance with another embodiment, the present invention provides a method for controlling image projection, comprising providing an electronic device having a projector and screen and varying a throw distance of an image cast from the projector onto the screen. The throw distance may be varied by increasing or decreasing a spacing between the screen and projector, and the screen may be moved using any one of the aforementioned extension members. Guide members may also be included for allowing the screen to be adjusted to predetermined throw distance settings. Also, the screen may be moved manually or automatically, for example, through activation of one or more servo-motor arrangements.

The foregoing embodiments may be combined to provide an electronic device which achieves the improved throw-distance control and size/weight advantages. This is especially beneficial in devices such as personal or portable computers, telecommunication devices, and other electronic systems which include at least a display for displaying images.

### BRIEF DESCRIPTION OF THE DRAWINGS

FIG. 1 is a diagram showing a portable computer including an LCD display system.

FIG. 2 is a diagram showing a portable computer including an image projection system.

FIG. 3 is a diagram showing the improper throw distance of the image projection system of FIG. 2.

FIG. 4 is a graph showing throw-distance curves for a variety of lens ratios and a range of screen widths that correspond to each of the curves.

FIG. 5 is a diagram showing an electronic device including a projection system which includes a foldable screen in accordance with one embodiment of the present invention.

FIG. 6 is a diagram showing relative size dimensions of the folded screen and housing of FIG. 5.

FIG. 7 is a diagram showing an unfolded state of the screen of FIG. 5.

FIG. 8 is a diagram showing one type of extension arrangement which may be used to vary the throw distance of the projection system of FIG. 5.

FIG. 9 is diagram showing an example of how the extension arrangement of FIG. 8 may be attached to the projection screen.

FIG. 10 is a diagram showing another type of extension arrangement which may be used to vary the throw distance of the projection system of FIG. 5.

FIG. 11a is a diagram showing a circuit for automatically moving the screen of the present invention, FIG. 11b is a diagram showing a switch with guide markings corresponding to predetermined throw distances that may be used in FIG. 11a, and FIG. 11c is a diagram showing a dial with guide markings that may be used FIG. 11a.

FIG. 12 is a diagram showing a control window that may be used for controlling movement of the screen relative to the projector in accordance with the present invention.

FIG. 13 is a diagram showing a fold-in screen that may be stored within the housing of the electronic device of FIG. 5.

FIG. 14 is a diagram showing a roll-in screen that may be stored within the housing of the electronic device of FIG. 5.

FIG. 15 shows an orientation-adjusting mechanism included in an electronic device containing an image projection system in accordance with the present invention.

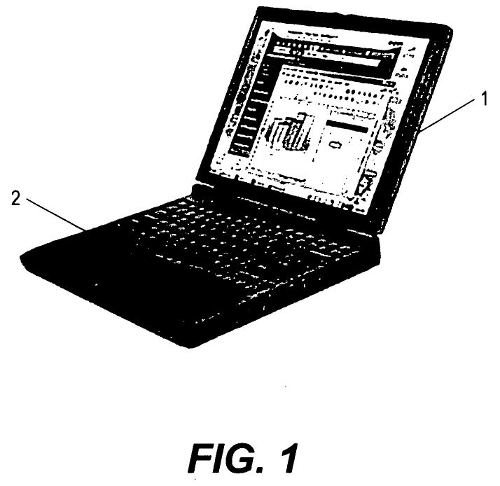

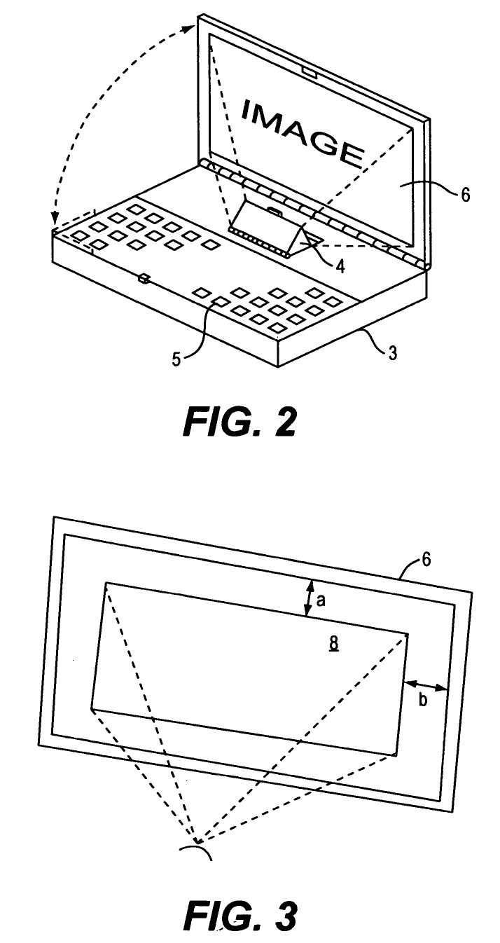

### DESCRIPTION OF THE PREFERRED EMBODIMENTS

The present invention is, in one respect, an image projection system for an electronic device wherein the screen of the projection system has at least one size dimension smaller than a corresponding size dimension of a housing of the device. In another respect, the invention is an image projection system for an electronic device that includes an adjuster which varies a throw distance of an image projected onto a screen. In the foregoing arrangements, the electronic device may be a stationary or portable computer, a communications device, or another product which displays images. The computer may be a desktop, laptop/notebook, tablet, or personal digital assistant or any other computing device that displays information. The communications device may be or include a mobile phone which may or may not be web-enabled. Other products that may be adapted to include the projection system of the present invention include but are not limited to media players, DVD players, mobile phones, PDAs, and video game players such as Playstation® and XBOX®. For illustrative purposes only, the projection system will hereinafter be described as being included within a portable computer.

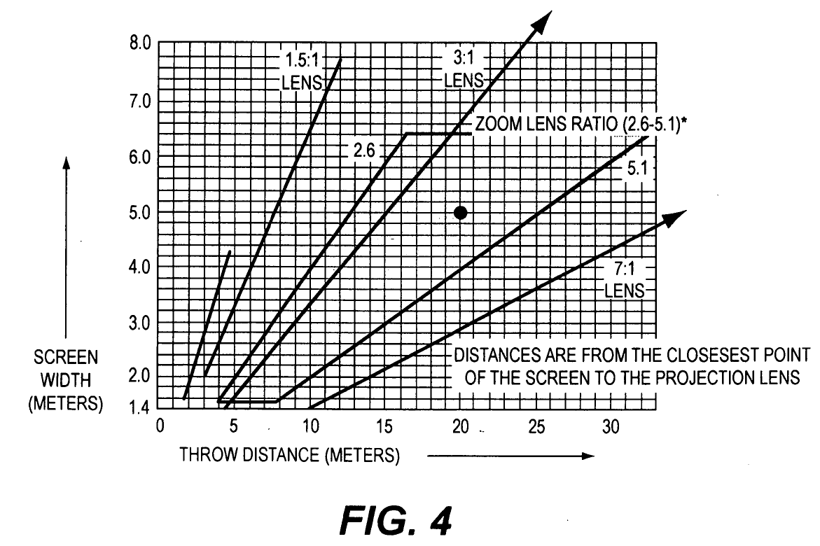

FIG. 4 is a graph showing throw-distance curves for a variety of lens ratios and a range of screen widths that correspond to each of the curves. Throw distance may be determined in a variety of ways, e.g., throw distance=projected image width*throw ratio. In this equation, the throw ratio is a characteristic of a lens of the projector. Usually, throw ratio of a projection lens is larger than 0.7:1, and the throw distance is usually larger than the image width. The graph of FIG. 4 thus shows that a proper throw distance should be used for a desired image size. Accordingly, U.S. Pat. No. 5,510,806 is not feasible with its given form factors.

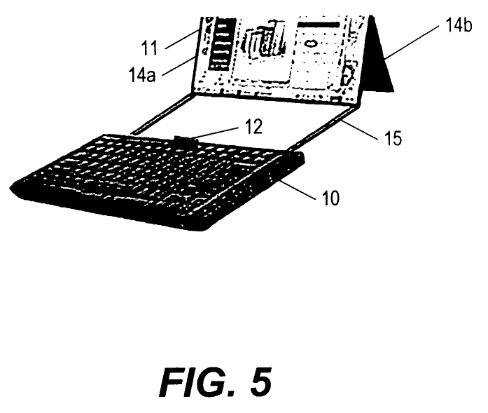

FIG. 5 shows an electronic device including a projection system according to one embodiment of the present invention. The electronic device includes a housing 10, a screen 11 connected to the housing, and an image projector 12 coupled to the housing in alignment with the screen. The housing may include a CPU, RAM and ROM memories, a hard disk, input devices such as a keyboard, track ball, and/or touch pad, floppy and/or CD/DVD disk drives, input/output ports, and one or more external peripherals.

The image projector may be located on a same side of the housing as the side to which the screen is connected. Many kinds of projector technologies may be used. Examples include microdisplays such as Digital Light Processing (DLP), liquid-crystal-on-silicon (LCOS), or organic light emitting diode (OLED). A color-sequential projector that uses a single microdisplay may also be used. This type of projector is advantageous because of its compact size and light weight, i.e., color-sequential projectors use LEDs as light sources instead of typical lamps. This reduces the overall size of the projector and is considered desirable for use with the present invention.

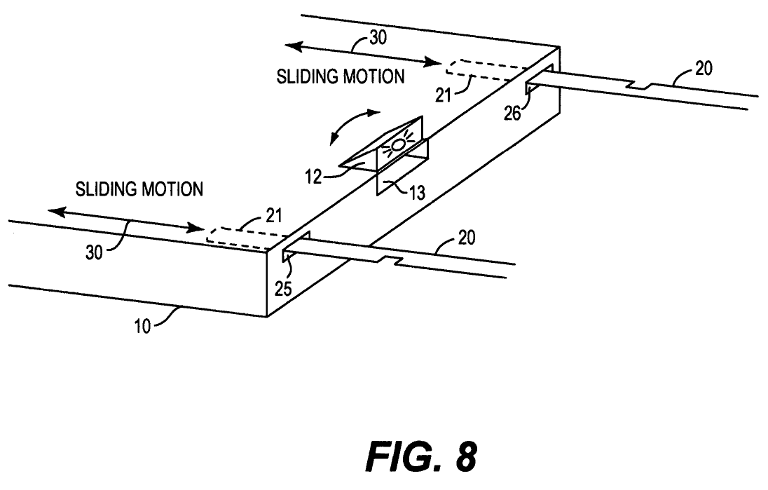

Preferably, the image projector is mounted to the computer housing so that it can rotate throughout a predetermined angular range. (See, e.g., FIG. 8). This will provide an additional degree of freedom for purposes of allowing the projected image to be adjusted relative to the screen. For the sake of convenience, the projector is preferably mounted along the edge of the computer housing to allow it to rotate into a recess 13 when not in use. In addition to these features, the projector may operate or otherwise include one or more of the following:
a color scrolling device with a lamp to maximize light utilization or alternating red, green, blue LEDs
red, green, and blue sub-frames for bright-image generation ( color-sequential projection)
operating the microdisplay projector at the same frame frequency more than 180 Hz to minimize color break-up artifacts (to be more inclusive)
pulse width modulation for representing gray scale levels Digital Micromirror Device)
fast switching LC modes such as optically compensated birefringence, pi cell, electrically controllable birefringence, and surface stabilized ferroelectric liquid crystal modes (LCOS)

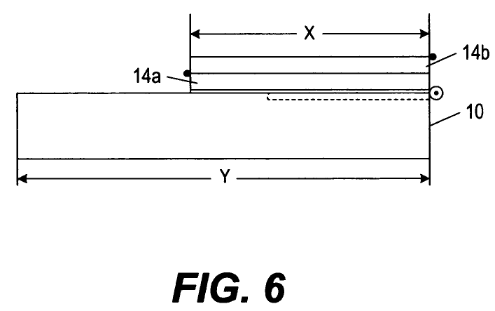

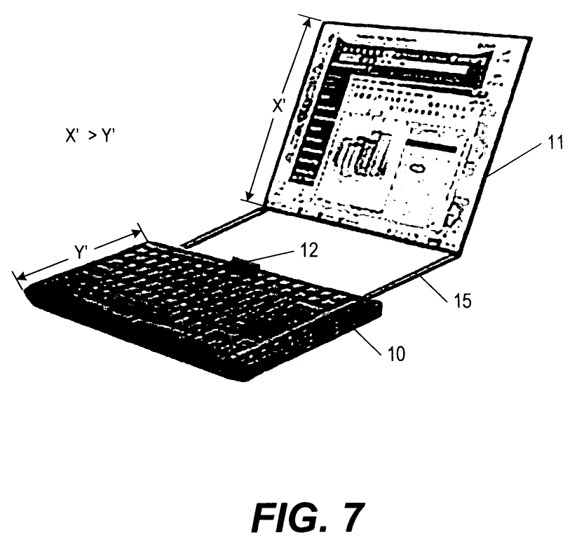

The screen has at least one size dimension which is different from a corresponding dimension of the housing. In order to achieve this size difference, the screen may be located on a board (e.g., made of plastic or other material) which is foldable into a predetermined number of sections. When designed in this manner, the height X of each section may be substantially smaller than the same dimension Y of the housing. (See FIG. 6). When unfolded, the screen may have a size X′ substantially the same as Y′ or this size may be larger or smaller depending, for example, on the number of folded sections used to design the screen. FIG. 7 shows an unfolded screen where X′>Y′.

For illustrative purposes, screen 11 is shown to have two sections 14a and 14b. These sections may be coupled together, for example, by a hinge, rubber connective strip, or any one of a variety of other known flexible or pivotal connective arrangements. The sections may be equal in size such as shown in FIG. 6, or the sections may have different sizes. Another dimension of the screen may be substantially the same as or different from a corresponding dimension of the housing, e.g., in FIG. 5 the widths of the housing and screen are shown to be substantially the same. FIG. 6 further shows that when the screen is in its retracted position, it may be stored at a position over the keyboard.

An adjuster 15 is used to couple the screen to the housing and is provided to vary a throw distance of an image cast from the projector onto the screen. The throw distance is varied by increasing or decreasing a spacing between the screen and projector. Preferably, this spacing is adjusted to achieve a one-to-one correspondence between the dimensions of the image and the screen, i.e., the width and height of the unfolded size screen is at least substantially the same as the width and height of the projected image. This ensures optimal viewing not only by the person using the computer but also by other on-lookers who may be nearby.

While this one-to-one correspondence may be optimal, the throw distance may be adjusted to other positions if desired. For example, the distance may be adjusted so that one or more of the dimensions of the projected image are less than the dimensions of the screen, or so that all or a portion of the image is projected on all or a portion of the sections.

The adjuster may be formed from one or more extension members which allow a position of the screen to be moved relative to the projector. As shown in FIG. 8, the extension members may include two rails 20, where each rail has a first end 21 coupled to the housing and a second end 22 coupled to the screen. The first end may be slidably mounted within the housing, so that in a retracted position the screen may be closed over the keyboard and in an extended position the screen may be adjusted to a desired throw distance and angle relative to the projector. The second end may be permanently or removably attached to the screen using screws or other known means of attachment. Also, the screen may be integrally formed with the support board or may be attached to the board using known techniques.

As also shown in FIG. 8, the housing may include slots 25 and 26 through which the rails slide (see arrows 30) for placing the screen in its retracted and extended positions as well as positions therebetween. To ensure that the screen remains at or between these positions, at least one sleeve (not shown) may be mounted inside the housing to frictionally engage the rails.

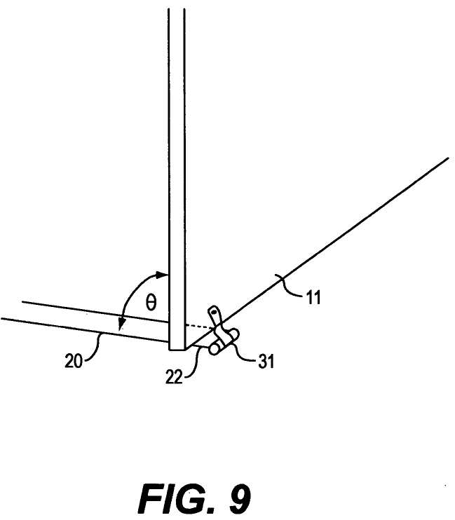

As shown in FIG. 9, the rails may be attached to the screen using hinges 31 or other known fastener arrangements which will allow the screen to rotate to at least one predetermined angle θ relative to the projector. Preferably, this angle is selected to optimize brightness of the projected image when the screen is extended to a predetermined throw distance. If desired, the extension member of the present member may be formed from only one rail which, for example, may extend within a longitudinally central portion of the housing. For stability purposes, however, a multiple-rail configuration may be preferable.

Also, while the rails are shown as being mounted on an upper portion of the housing, alternative embodiments contemplate having the rails project from a bottom portion or the sides of the housing. In these alternative embodiments, the rails may slide within a clearance space located, for example, under or along respective sides of the keyboard. Also, the screen may be provided with an extra fold or extension hinges in order to allow the screen to close over the keyboard in its retracted position.

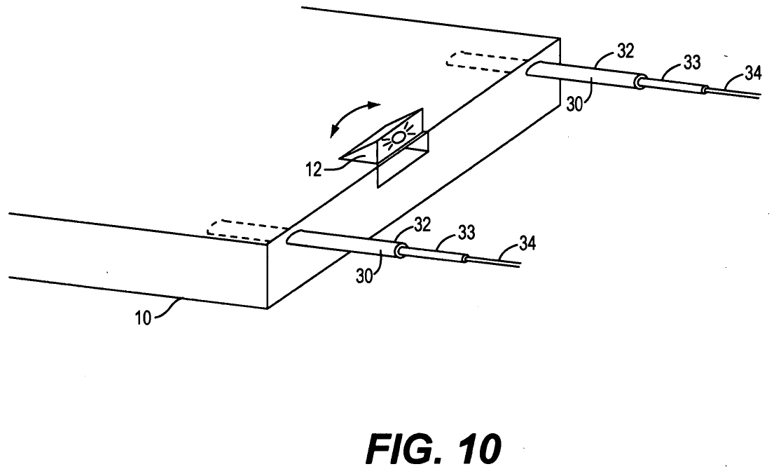

FIG. 10 shows an alternative arrangement for the extension members. This arrangement includes two telescoping rails 30, each having sections 32, 33, and 34 whose lengths preferably correspond to predetermined throw distance settings when extended. For example, when the screen is telescopically extended by the length of section 32 only, the image is projected at a first throw distance onto the screen. When the screen is extended by lengths 32 and 33, the image is projected at a second throw distance onto the screen.

When projected at the first and second throw distances, the image may not coincide with the full dimensions of the screen. The third section 34 may be provided for this purpose, i.e., when fully extended by lengths of sections 32-34 a one-to-one correspondence may exist between the dimensions of the projected image and screen. The telescopic sections thus serve as a guide for different throw distance settings. In alternative embodiments, the extension members may be formed from a different number of sections. Also, the distal ends of the extensions may be fastened to the screen using any manner of attachment previously discussed herein.

The adjuster may be automatically or manually controlled to achieve a desired throw distance.

Manual control of the adjuster may be accomplished by a user pulling or pushing the screen to extend or retract the extension members to a desired position. If the adjuster includes one or more rails which slide through slots in the housing, the guides may be formed as notches in the rail which correspond to predetermined throw distances. If the guides are formed as telescoping rails, the length of each telescoping portion may corresponding to a predetermined throw-distance setting. Other manual arrangements are also possible.

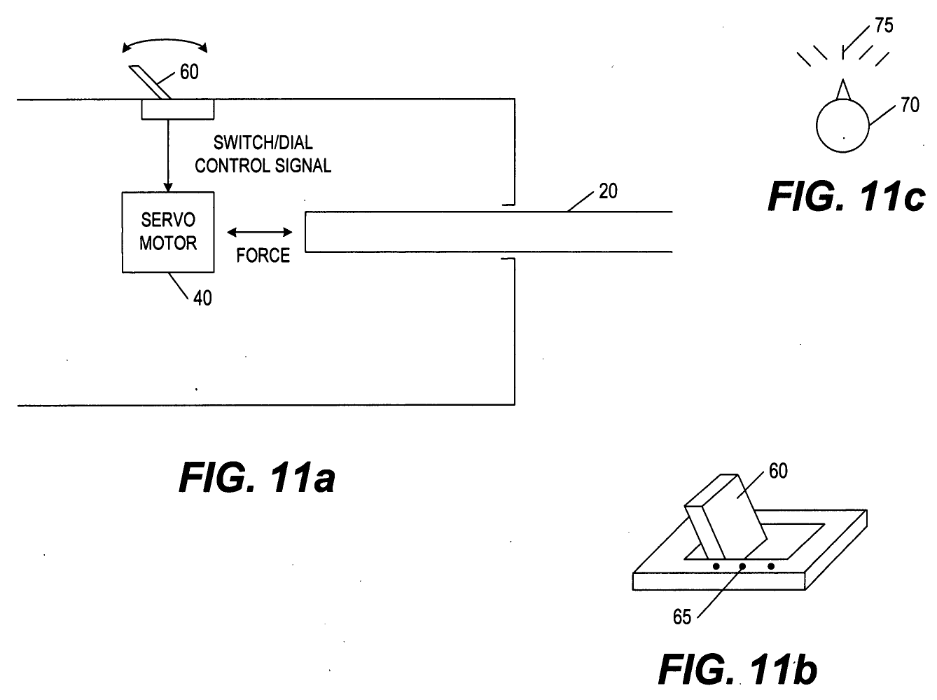

Automatic control may be achieved through small servo motors included in the device housing. FIG. 11a shows a servo motor 40 which may be used to extend one of the rails 20 to a predetermined throw distance. A similar motor (not shown) may be used to extend the other rail by the same amount, i.e., the motors controlling the rails may be synchronized. A similar arrangement may be used to extend the sections of the telescopic rails of FIG. 10 if desired.

To assist a user in controlling the throw distance, a switch or dial 60 may optionally be included on or otherwise coupled to the housing for operating the motors. The switch may have one or more guide markings 65 (FIG. 11b) corresponding to preset throw distances, i.e., when the switch is adjusted to these settings the motors control extension and retraction of the screen to positions which correspond to these settings. FIG. 11c shows a dial 70 including markings 75 which may be included for controlling the motor.

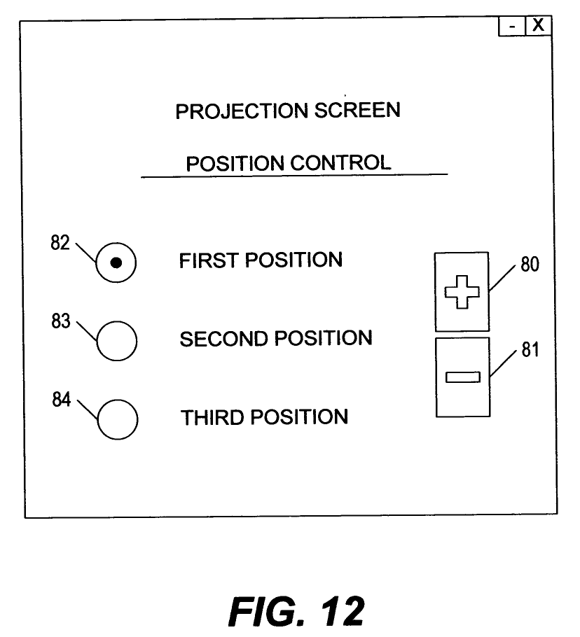

In an alternative embodiment, the distance between the projector and screen may be varied by control software, which, for example, causes one or more soft-switch icons or control windows to be displayed for manipulation by a user. As shown in FIG. 12, these icons may include switches 80 and 81 for increasing and decreasing the position of the screen relative to the projector. Also, guides may be programmed into the control software for regulating the distance between the projector and screen to predetermined settings. Switches 82, 83, and 84 are provided to illustratively show three programmed position settings.

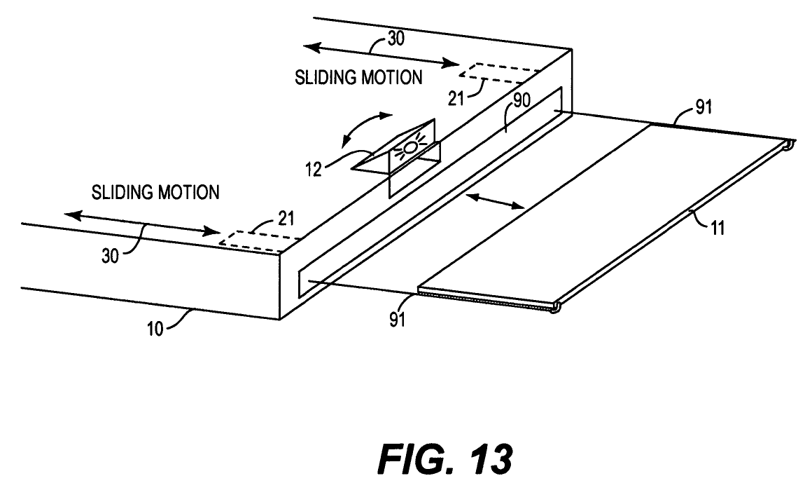

Also, to provide seamless images, the screen may be a slide-in or roll-in type. In a slide-in configuration, the screen that may be adapted to slide within a slot 90 formed in the housing of the electronic device. FIG. 13 shows an example of this configuration, where the folded screen 11 is pivotally attached to a set of rails 91 which may be any of the types previously mentioned. When the screen is rotated to a position such that the screen is located between the rails, the rails and screen (supported, for example, on a slidable chassis) may be pushed into the slot for storage within the housing.

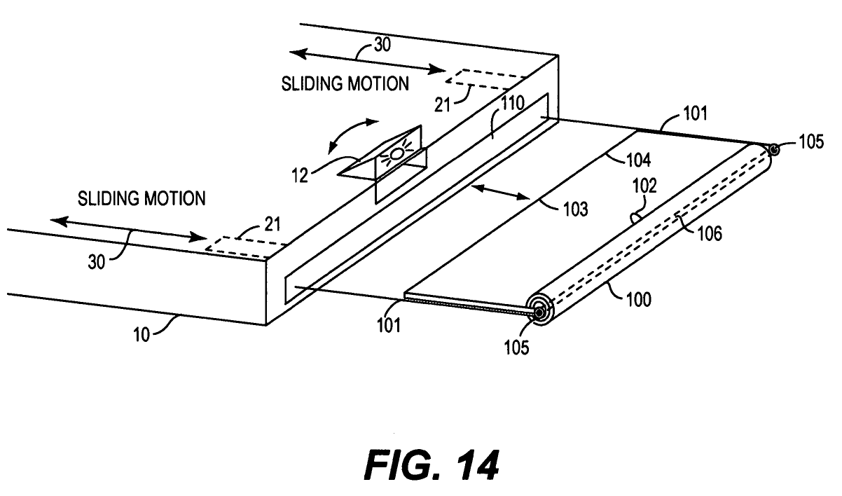

FIG. 14 shows an alternative arrangement where a rolling screen 100 is supported between rails 101. To view an image, the screen is unrolled and an a loop 102 on the screen is attached to a hook 103 located on a third support member 104, which may also be rotatably connected to the rails respectively at pivot points 105. A support rod 106 may be included for supporting the screen between the rails. To store the screen, the screen is unhooked and the screen automatically rolls up by action of a spring biasing member attached, for example, to rod 106. The third support member is then rolled to a position between the rails and the entire assembly is moved either manually or automatically into slot 110 in the housing.

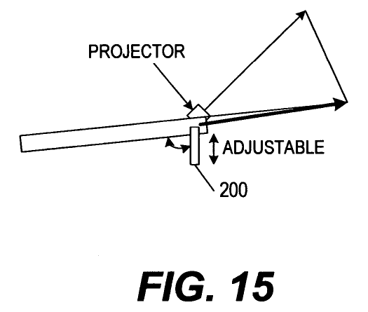

FIG. 15 shows that an orientation-adjusting mechanism may be included in the electronic device containing the image projection system of the present invention. This mechanism may, for example, include a stud 200 which rotates from a retracted position to slant the device to a predetermined angle. The stud may also be vertically adjustable to control a height of the device. Adjusting orientation in this manner may have the effect of performing keystone correction, for example, by making projector perpendicular to the screen. Keystone correction adjusts for the fact that if a projector is directed towards the screen at an angle, the projected image will be distorted; the edge furthest away from the projector will be wider than the edge closest to the projector. In other words, the image will appear in the shape of a trapezoid.

In another alternative embodiment, the image projection system may include a combination of a rolling screen and a foldable, slidable or telescoping support. Because the foldable screen may have a tendency to generate lines on the display surface, a rolling screen may be preferable to preserve image quality in this or other embodiments. The support may slide into the computer and include a rod for supporting the screen, and if the support is foldable it may cover upper parts of the computer when the computer is not in use.

In yet another alternative embodiment, the screen may be a stand-alone screen or a wall-mounted screen onto which images may be projected. This will add more value to portable systems incorporating the invention, e.g., video game stations which need to be connected to a television for displaying images. A stand-alone or wall-mounted screen may also allow for a more compact system since this concept only requires space for a miniature projector. Also, the stand-alone or wall-mounted screen will provide a care-free presentation environment without requiring a separate front projector, which is an advantage which built-in screen embodiments may not always be able to achieve.

In any of the foregoing embodiments, the image projection system may further include a device or control system for adjusting the focus of the image from the projector. The device or control system may allow a user to manually adjust the focus of the projected image or this adjustment may be automatically performed, for example, based on a user input signal. The user input signal may derive from a switch coupled to the housing the host device, or from control software which, for example, causes a control window to be displayed with icons that can be selected for changing focus. Other devices and/or systems may also be used.

While certain embodiments of the invention have been specifically described herein, it will be apparent that numerous modifications may be made thereto without departing from the spirit and scope of the invention. For example, while the screen is has been described as being attached to extension members, in an alternative embodiment a stand-alone screen may be used, e.g., one that is completely detached from the electronic device housing but which is supported in alignment with the projector.

1. An electronic device, comprising:
a housing;
a screen connected to the housing; and
an image projector coupled to the housing in alignment with the screen,
wherein at least one size dimension of the screen is substantially different from a corresponding size dimension of the housing.

2. The device of claim 1, wherein another size dimension of the screen is at least substantially equal to a corresponding size dimension of the housing.

3. The device of claim 1, wherein the screen is foldable and wherein the at least one size dimension of the screen is substantially smaller than a corresponding dimension of the housing when the screen is in a folded state.

4. The device of claim 3, wherein the screen folds into a predetermined number of sections.

5. The device of claim 4, wherein the predetermined number is two.

6. The device of claim 4, wherein the sections are of equal size.

7. The device of claim 1, wherein the image projector is spaced from the screen by a throw distance which causes the projected image to have at least one dimension substantially equal to a corresponding dimension of the screen.

8. The device of claim 1, wherein the image projector and screen are connected to a same side of the housing.

9. The device of claim 8, wherein the housing includes a keyboard and wherein said side is a rear side of the housing behind the keyboard.

10. The device of claim 1, further comprising:
at least one member for extending a position of the screen relative to the housing.

11. The device of claim 10, wherein said at least one member includes a rail which is sidably connected to the housing.

12. The device of claim 10, wherein said at least one member includes:
first and second rails, each of which is slidably connected to the housing.

13. The device of claim 12, wherein the first rail is connected to one size of the screen and the second rail is connected to an opposing side of the screen.

14. The device of claim 10, wherein said at least one member telescopically extends from the housing.

15. The device of claim 10, wherein said at least one member is slidably connected within a slot in the housing.

16. The device of claim 10, wherein the slot and a keyboard are located on opposing sides of the housing.

17. The device of claim 12, wherein the first and second rails are slidably connected to opposing sides of the housing.

18. The device of claim 1, wherein the electronic device is a portable computer.

19. The device of claim 18, wherein the portable computer is a personal digital assistant.

20. The device of claim 1, wherein the electronic device is a telecommunications device.

21. The device of claim 1, further comprising:
means for adjusting a focus of the image projector.

22. The device of claim 21, wherein the focusing means includes:
an adjuster which allows a user to manually adjust the focus of the image projector.

23. The device of claim 21, wherein the focusing means includes:
a control unit which automatically adjusts the focus of the image projector based on a user input signal.

24. The device of claim 23, wherein the control unit includes a switch located on the housing.

25. The device of claim 23, wherein the user input signal is initiated by activation of an icon on the screen.

26. An electronic device, comprising:
a housing;
a screen connected to the housing;
an image projector coupled to the housing in alignment with the screen; and
an adjuster which varies a throw distance of an image cast from the projector onto the screen.

27. The device of claim 26, wherein the adjuster varies the throw distance by increasing or decreasing a spacing between the screen and projector.

28. The device of claim 27, wherein the adjuster includes:
at least one extension member which moves the screen relative to the projector.

29. The device of claim 28, further comprising:
at least one guide member formed on or coupled to the at least one extension member to regulate the throw distance to one or more predetermined settings.

30. The device of claim 28, wherein the at least one extension member includes:
at least one rail having a first end coupled to the screen and a second end coupled to the housing.

31. The device of claim 30, wherein the rail is a telescopic rail.

32. The device of claim 30, further comprising:
a number of slots in the housing,
wherein the number of slots and rails are equal and wherein the rails telescopically project from respective ones of the slots to adjust the throw distance.

33. The device of claim 28, further comprising:
a circuit which controls the extension member to automatically move the screen relative to the projector.

34. The device of claim 33, further comprising:
at least one guide to regulate the extension member to move the screen to one or more predetermined positions relative to the projector.

35. The device of claim 33, wherein the circuit controls a motor within the housing to move the extension member relative to the screen.

36. The device of claim 35, further comprising:
a control window displayed on the screen,
wherein the control window includes at least one soft-switch icon for controlling movement of the extension member through activation of the motor.

37. A method for controlling image projection, comprising:
providing an electronic device having a projector and screen; and
varying a throw distance of an image cast from the projector onto the screen.

38. The method of claim 37, wherein varying the throw distance includes increasing or decreasing a spacing between the screen and projector.

39. The method of claim 37, wherein varying the throw distance includes:
moving the screen on at least one extension member attached to a housing of the electronic device.

40. The method of claim 39, wherein said at least one extension member includes a telescopic rail.

41. The method of claim 39, wherein moving the screen including moving the screen relative to guide members set to predetermined throw distance settings.

42. The method of claim 39, wherein moving the screen includes:
activating a circuit which controls a motor to automatically move the screen relative to the projector.
